(19) United States
(12) Patent Application Publication
(10) Pub. No.: US 2015/0345717 A1
(43) Pub. Date: Dec. 3, 2015

(54) ASSEMBLY FOR POWERING AND CONTROLLING ARRAYS OFLIGHT EMITTING DIODES

(71) Applicants: Matthew Gerpheide, Poway, CA (US); Phuoc N. Nguyen, San Diego, CA (US)

(72) Inventors: Matthew Gerpheide, Poway, CA (US); Phuoc N. Nguyen, San Diego, CA (US)

(21) Appl. No.: 14/562,748

(22) Filed: Dec. 7, 2014

Related U.S. Application Data
(60) Provisional application No. 62/006,847, filed on Jun. 2, 2014.

(51) Int. Cl. F21L 4/08; F21V 31/00; F21V 23/04; F21L 4/02; F21V 23/00

(52) U.S. Cl. CPC F21L 4/08; F21L 4/02; F21V 23/001; F21V 23/0435; F21V 23/0471; F21V 23/0414; F21V 23/0485; F21V 23/0464; F21V 31/00; F21L 2001/00

(57) ABSTRACT

An LED control assembly that includes an LED controller circuit for controlling the operation of external LEDs. A power supply unit provides electrical power to the external LEDs, wherein the power supply unit includes a battery. One or more switches, receivers, or sensors provide user control of the LED controller circuit. Also, an electrical connector provides electrical connections to the external LEDs. An enclosure provides a housing for the LED controller circuit, the power supply unit, the switches, receivers, or sensors, and the electrical connector, wherein the enclosure protects components inside from external elements.

### RELATED APPLICATIONS

This application claims priority from U.S. provisional application No. 62/006,847 filed on Jun. 2, 2014, which is incorporated by reference in its entirety for all purposes.

### FIELD OF THE INVENTION

The present invention generally relates to portable light emitting diode (LED) assemblies, and more particularly to a portable assembly for powering and controlling arrays of LEDs.

### BACKGROUND OF THE INVENTION

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Advances in LED lighting have brought about many new possibilities in lighting. For example, the small size and low power consumption of current LED arrays has enabled many new applications for portable lighting that were not practical with incandescent light bulbs. These include LED arrays that can be worn on clothing by persons or animals, can be attached to portable objects, or attached to places or objects where extension cables may be impractical or undesirable.

There are still limitations in the possible uses of portable LEDs due to a number of factors. Thus it would be desirable to increase the flexibility and versatility of LED arrays so that they can be used more effectively and easily in portable applications. For example, in prior portable LED assemblies, the electrical controller that controls the LEDs and the battery are typically mounted in separate locations. This requires two separate units to be mounted thus adding to the bulk and complexity of the LED system. This makes the LED assembly less useful for wearable applications, where simple, small, and concealable mounting is desired. Also, in some portable LED assemblies, where the controller and battery are located in different locations, exposed wiring is needed to provide electrical connections between the two components. This increases the likelihood of damage or disconnection of the components, particularly in portable applications where there may be significant movement or exposure to the elements that can cause the external electrical connections to be damaged or disconnected.

In some portable LED assemblies, the LED strip containing the LED units is directly plugged into the battery pack or is directly connected to the LED controller. By having the LED strip mechanically coupled to the battery pack or to the LED controller, movement of the LED strip can cause damage to or disconnection of the electrical connection between the LED strip and the controller. In some portable LED assemblies there is little flexibility in how the battery pack, controller and LED strip are interconnected and mounted, and a desired configuration may require custom wiring and soldering.

Thus it would be desired to provide a portable LED assembly that overcomes the limitations described above.

### SUMMARY OF THE INVENTION

This section is intended to provide a summary of certain exemplary embodiments and is not intended to limit the scope of the embodiments that are disclosed in this application.

One aspect of the disclosed embodiments relates to an LED control assembly that includes an LED controller circuit for controlling the operation of external LEDs. A power supply unit provides electrical power to the external LEDs, wherein the power supply unit includes a battery. One or more control devices provide user control of the LED controller circuit. Also, an electrical connector provides electrical connections to the external LEDs. An enclosure provides a housing for the LED controller circuit, the power supply unit, the control devices, and the electrical LED controller to LED array connector, wherein the enclosure protects components inside from external elements and forces.

Another aspect of the disclosed embodiments relates to an LED control assembly that includes an LED controller circuit for controlling the operation of external LEDs A power supply unit provides electrical power to the external LEDs, wherein the power supply unit includes a battery. One or more control devices provide user control of the LED controller circuit. An electrical connector provides electrical connections to the external LEDs. An enclosure is provided for housing the LED controller circuit, the power supply unit, the one or more control devices, and the electrical connector, wherein the enclosure protects components inside from external elements. A wireless receiver within the enclosure for receives wireless signals from outside the enclosure that control the operation of the LED controller circuit, wherein the wireless receiver receives signals from a portable electronic device to control the operation of the LED controller circuit.

Another aspect of the disclosed embodiments relates to an LED control assembly that includes an LED controller circuit for controlling the operation of external LEDs. A power supply unit provides electrical power to the external LEDs, wherein the power supply unit includes a battery. One or more control devices provide user control of the LED controller circuit. An enclosure provides a housing for the LED controller circuit, the power supply unit, the control devices, and the electrical LED controller to LED array connector, wherein the enclosure protects components inside from external elements and forces.

An advantage of the present invention is that because the controller and the battery are housed in the same enclosure, the controller and battery are protected from damage during use or from the elements. Another advantage is that only a single unit needs to be mounted instead of having to mount both a battery pack and a controller unit. This simplifies the mounting, takes up less space and makes it easier to conceal the battery pack and controller when mounting on clothing. Also, by mounting the controller and the battery pack in a single unit, external wires are not needed to connect the controller with the battery pack. This reduces the likelihood of such external connections becoming damaged or disconnected during use, particularly in wearable or portable applications where there may be significant movement during use.

These and other advantages and features of disclosed embodiments, together with the organization and manner of operation thereof, will become apparent from the following detailed description when taken in conjunction with the accompanying drawings.

### BRIEF DESCRIPTION OF THE DRAWINGS

The disclosed embodiments are described by reference to the attached drawings.

FIG. 1 shows a block diagram of a portable LED assembly in accordance with an example embodiment.

FIG. 2 shows a sectional view of an LED control assembly in accordance with an example embodiment.

FIG. 3 shows a top view of the LED control assembly shown in FIG. 3 in accordance with an example embodiment.

FIG. 4 shows a side view of the LED control assembly shown in FIG. 3 in accordance with an example embodiment.

FIG. 5 shows a bottom view of the LED control assembly shown in FIG. 3 in accordance with an example embodiment.

FIG. 6 shows an end view of the LED control assembly shown in FIG. 3 in accordance with an example embodiment.

FIG. 7 shows a circuit diagram of an LED control assembly in accordance with an example embodiment.

FIG. 8 shows a sectional view of a cylindrical LED control assembly in accordance with an example embodiment.

FIG. 9 shows a lower sectional view of a cylindrical LED control assembly in accordance with an example embodiment.

FIG. 10 shows a top view of the cylindrical LED control assembly shown in FIG. 8 in accordance with an example embodiment.

FIG. 11 shows a sectional side view of the LED control assembly shown in FIG. 10 in accordance with an example embodiment.

FIG. 12 shows an end view of the LED control assembly shown in FIG. 10 in accordance with an example embodiment.

FIG. 13 shows an opposite end view of the LED control assembly shown in FIG. 10 in accordance with an example embodiment.

FIG. 14 shows the wireless LED controller and cell phone remote in accordance with the example embodiment.

FIG. 15 shows a top view of a square LED control assembly in accordance with an example embodiment.

FIG. 16 shows a sectional view of a square LED control assembly in accordance with an example embodiment.

FIG. 17 shows a lower sectional view of a square LED control assembly in accordance with an example embodiment.

FIG. 18 shows an end view of the square LED control assembly shown in FIG. 15

FIG. 19 shows a sectional view of the square LED control assembly shown in FIG. 15

FIG. 20 shows an opposite end view of the square LED control assembly shown in FIG. 15

FIG. 21 shows a side view of the square LED control assembly shown in FIG. 15

FIG. 22 shows a flexible end side view of the square LED control assembly shown in FIG. 15

FIG. 23 shows a flexible side view of the square LED control assembly shown in FIG. 15

FIG. 24 shows a personal computer or smart device in accordance with the example embodiment

FIG. 25 shows a top view of the LED control assembly in accordance with an example embodiment.

FIG. 26 shows a sectional view of an LED control assembly shown in FIG. 25 in accordance with an example embodiment.

FIG. 27 shows an end view of the LED control assembly shown in FIG. 25 in accordance with an example embodiment.

FIG. 28 shows an opposite end view of the LED control assembly shown in FIG. 25 in accordance with an example embodiment.

FIG. 29 shows a sectional view of the LED control assembly shown in FIG. 28 in accordance with an example embodiment.

FIG. 30 shows a side view of the LED control assembly shown in FIG. 25 in accordance with an example embodiment.

FIG. 31 shows a bottom view of the LED control assembly shown in FIG. 25 in accordance with an example embodiment.

FIG. 32 shows a piece of attachment material in accordance with an example embodiment.

FIG. 33 shows an attachment clip in accordance with an example embodiment.

FIG. 34 shows a sectional view of the attachment clip shown in FIG. 33 in accordance with an example embodiment.

FIG. 35 shows an example usage of the LED control assembly shown in FIG. 25 in accordance with an example embodiment.

FIG. 36 shows an example usage of the LED control assembly used with LED pants.

FIG. 37 shows an example usage of the LED control assembly used with an LED screen.

FIG. 38 shows an example usage of the LED control assembly used with a surfboard/paddle board with LEDs.

FIG. 39 shows an example usage of the LED control assembly used with LEDs wrapped around a tree.

FIG. 40 shows an example usage of the LED control assembly used with LEDs mounted on a guitar.

FIG. 41 shows a top view of the LED control assembly with a cable and cable connector in accordance with an example embodiment.

FIG. 42 shows a perspective view of the LED control assembly with a cable and cable connector shown in FIG. 41 in accordance with an example embodiment.

FIG. 43 shows an example usage of the LED control assembly used with LEDs mounted on a hand held advertising sign

FIG. 44 shows a top view of the LED control assembly in accordance with an example embodiment.

FIG. 45 shows a sectional view of the LED control assembly shown in FIG. 44 in accordance with an example embodiment.

FIG. 46 shows a top view of a wireless charging apparatus used by the LED control assembly shown in FIG. 44 and FIG. 45.

### DETAILED DESCRIPTION OF THE INVENTION

In the following description, for purposes of description and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

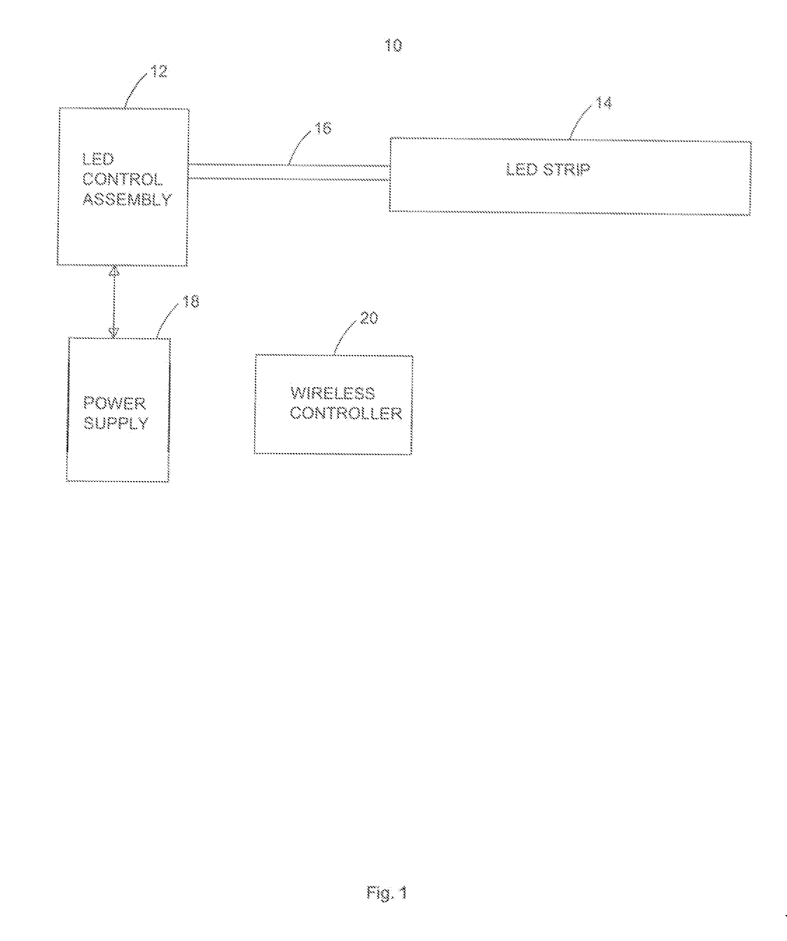

FIG. 1 shows a block diagram of a portable LED assembly 10 in accordance with an example embodiment. An LED control assembly 12 is connected to an LED strip 14. The LED control assembly 12 contains all of the components necessary to provide electrical power and control to the LED strip 14, as described in more detail below. The LED strip 14 may comprise an array of LEDs, such as an array of surface mounted LEDs. The LED strip may comprise an individually addressable LED BGreenBid WS2812b LED Pixel Strip with an IP68 waterproofing rating. Alternatively, the LED strip may also comprise a group addressable LED TaoTronics® TT-SL001 12 volt LED strip with an IP65 waterproofing rating.

The portable LED assembly 10 also includes a cable 16 that provides an electrical connection between the LED control assembly 12 and the LED strip 14. The cable 16 carries the appropriate number of wires to provide electrical power and control signals to the LED strip 14. The LED assembly 10 also, in some embodiments, provides a power supply unit 18, which may be used to directly provide power to the LED control assembly 12 or may be used to provide power to recharge the battery or batteries within the LED control assembly 12. The portable LED assembly may also include a wireless controller 20, which may allow a user to wirelessly control the operation of the LED strip 14 in some embodiments.

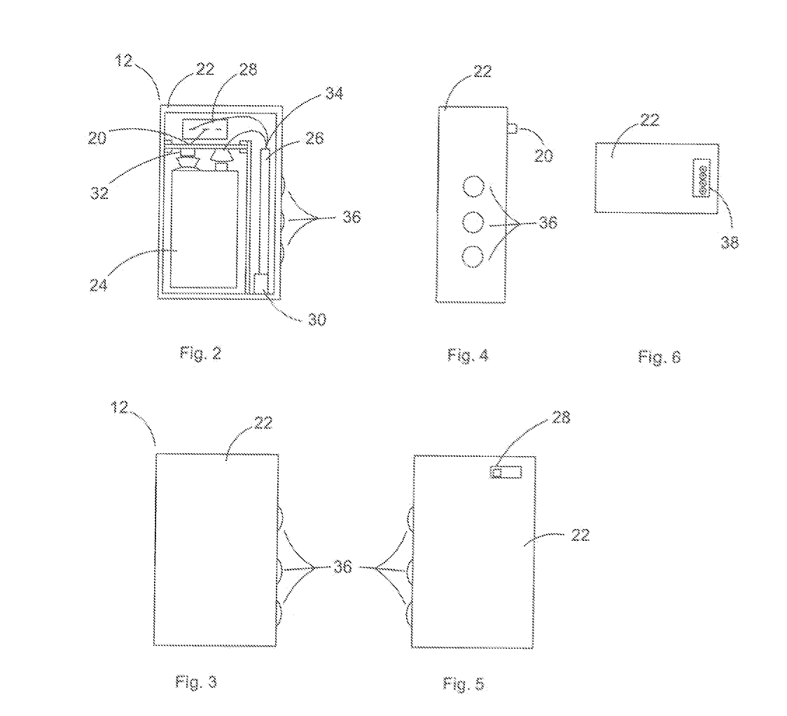

FIG. 2 shows a sectional view of the LED control assembly 12 in accordance with an example embodiment. A rectangular housing unit 22 encloses the contents of the LED control assembly 12. These contents include a battery 24, an LED controller 26, an on/off switch 28, an LED control connector 30, battery connectors 32, power wiring 34, and button switches 36. The battery 24 may comprise a conventional disposable or rechargeable battery, such as a 12 Volt battery. The LED controller 26 may comprise a conventional LED controller integrated circuit such as a Qingf Model Number: M6A12V-M3Q-T1 LED controller.

FIG. 3 shows a top view of the LED control assembly 12 shown in FIG. 2 in accordance with an example embodiment. FIG. 4 shows a side view of the LED control assembly shown in FIG. 3 in accordance with an example embodiment from which the button switches 36 can be seen.

FIG. 5 shows a back view of the LED control assembly 12 shown in FIG. 3 in accordance with an example embodiment, from which the on/off switch 28 can be seen.

FIG. 6 shows an end view of the LED control assembly 12 shown in FIG. 3 in accordance with an example embodiment. An opening 38 in the housing unit 22 can be seen which provides outside access to the LED controller connector 30.

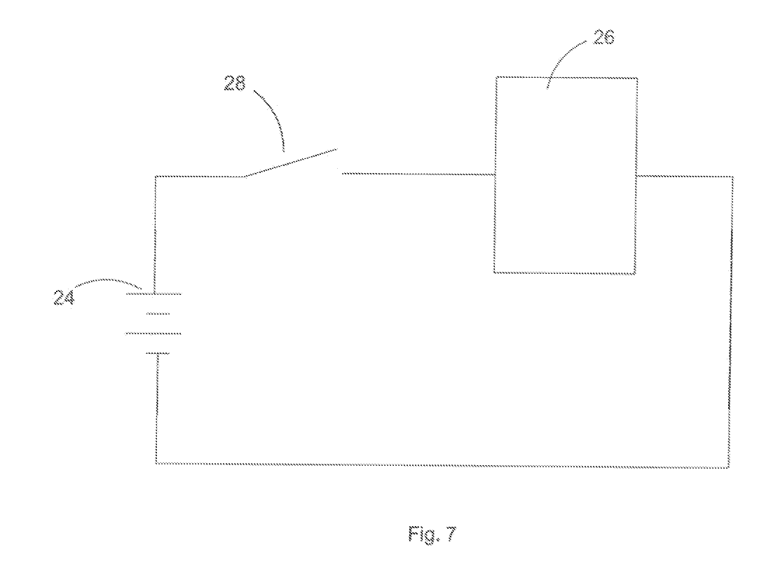

FIG. 7 shows a circuit diagram of an LED control assembly in accordance with an example embodiment. Direct current (DC) electrical current is provided by the battery 24 to the LED controller 26 through the on/off switch 28.

The LED control assembly 12 operates by providing power from the battery 24 to the LED controller 26 through the on/off switch 28. The operation of the LED controller 26 may be controlled by the user by using the button switches 36. Control signals from the LED controller 26 are sent through the LED control connector 30 to an LED strip 14. The control signals sent by the LED controller 26 may include signals controlling the color, on/off pattern, and brightness fading effects of the LED strip 14. These three LED control factors may be controlled by the user using the three button switches 36.

The housing unit 22 may be configured to retain all of the internal in a compact space. Also, it is desirable for the housing unit 22 to provide protection from the elements and to provide some measure of shock protection. The housing unit 22 may be constructed of plastic or other sufficiently strong material such as metal, fiber reinforced polymers, and other suitable materials. In typical embodiments, the housing unit 22 may be 1-6 inches long, 1-6 inches wide, and ¼ inch to 3 inches deep, although other dimensions are possible depending on the particular application. The battery 24 may comprise 1.5 Volt, 3.7 Volt, 9 Volt, 12 Volt, or other voltage batteries. The battery 24 may comprise one or more AA, AAA, C cell, D cell, coin cell, or other styles of batteries, or custom-designed batteries.

The LED control connector 30 may comprise a Universal Serial Bus (USB), 2, 3, or 4 pin connectors, custom connectors, or other LED array or strip connectors. The on/off switch 28 and the button switches 36 may comprise slide switches, button switches, toggle switches, dial switches, or other kinds of switches.

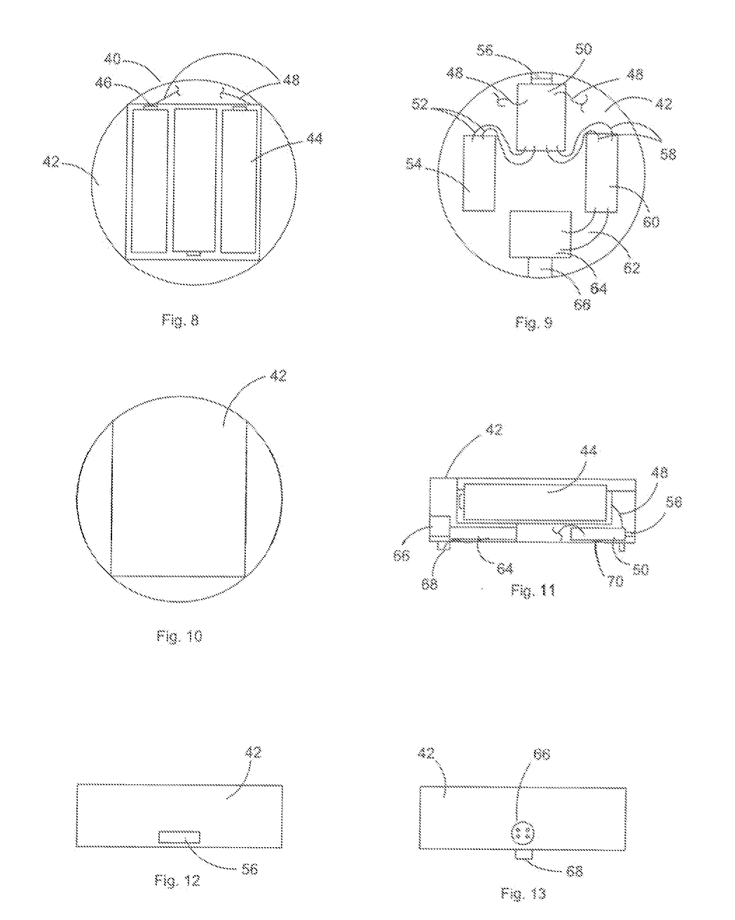

FIG. 8 shows a sectional view of a cylindrical LED control assembly 40 in accordance with an example embodiment. This embodiment includes a cylindrical-shaped housing 42 instead of the rectangular-shaped housing 22 shown in FIG. 2. In typical embodiments the cylindrical-shaped housing 42 may be 1-4 inches in diameter, and ¼ inches to 2 inches deep although other dimensions are possible depending on the particular application. The batteries 44 comprise multiple AAA 1.5 volt rechargeable batteries connected through power control terminals 46 to power wiring 48.

FIG. 9 shows a lower sectional view of the cylindrical LED control assembly 40 in accordance with an example embodiment. The power wiring 48, from FIG. 8, is connected to a charging circuit board 50 that connects to a battery life indicator circuit board 54, through power wiring 52. The charging circuit board 50, is also connected to an input charging port 56. The charging circuit board 50, is additionally connected to a voltage step up circuit board 60, through power wiring 58. The step up voltage circuit board 60, is connected to a wireless LED controller 64, through power wiring 62. The wireless LED controller 64, is connected to a power and data output connector 66, which can be connected to an LED array. The wireless LED controller 64 may comprise a Green Lantern Model No: GL-KZQ-WBLV-370 wireless Bluetooth RGB LED controller. The LED strip may comprise a group addressable LED TaoTronics® TT-SL001 12 volt LED strip with an IP65 waterproofing rating.

The charging circuit board 50, accepts power from an external power source 18, shown in FIG. 1, through the input charging port 56 and converts it to the appropriate voltage to charge the batteries 44. The charging circuit board 50, protects the batteries 44 from harmful voltage ranges and currents while charging the batteries 44. The charging circuit board 50 also protects the batteries 44 from over discharging to dangerously low voltage and low current levels. The charging circuit board 50 also has charging indicating lights 70 shown in FIG. 11, which show a visual depiction of the charging status of the LED control assembly 12, 40. The charging circuit board 50, transmits battery power through the power wires 52, to the battery life indicator circuit board 54. The battery life indicator circuit board 54, indicates the remaining battery life of the LED control assembly 12, 40. The charging circuit board 50, also transmits battery power through the power wires 58, to the voltage step up circuit board 60. The voltage step up circuit board takes in the incoming battery power from the batteries 44, and converts it up to the preferred operating voltage of the wireless LED controller 64 and LED strip 14.

FIG. 10 shows a top view of the cylindrical LED control assembly shown in FIG. 8 in accordance with an example embodiment. FIG. 11 shows a sectional side view of the LED control assembly shown in FIG. 8 in accordance with an example embodiment. FIG. 12 and FIG. 13 show a side view of the LED control assembly shown in FIG. 8 in accordance with an example embodiment. In the embodiment shown in FIGS. 8-13, the LED control assembly 40 includes a wireless receiver 68, which permits the operation of the LED strip 14 to be controlled by a wireless controller 20, as shown in FIG. 1. The wireless controller 20 may send signals wirelessly to the wireless receiver 68 and may replace the button switches 36. For example, the wireless controller 20 may send infra-red signals, or various kinds of signals including Bluetooth or Bluetooth Low Energy (BLE). The wireless controller may comprise a smart phone with an app configured to control the LED strip 14. In some embodiments, the control of the LED strip may be through voice control, music control, motion control, light sensors, touch screen, or other types of sensors.

FIG. 14 shows the wireless LED controller 64 components and an application capable cell phone. A cell phone 65, with appropriate application 67 installed, sends commands or color, pattern, and brightness, using a wireless Bluetooth signal 69a. The wireless Bluetooth signal 69b is received by a wireless receiver 68, and then interpreted by the LED controller 64. The LED controller 64 then relays the user commanded information to control the attached LED strip 14. Further details of ways to wirelessly control devices such as the wireless LED controller 64 using a portable device are disclosed in the following documents, which are incorporated herein by reference: U.S. Pat. No. 8,659,400; Chinese patent no. CN203202730; and U.S. patent application nos. 20120303138, 20140025795, and 20140040035.

FIG. 15 shows a top view of a square LED control assembly 72 in accordance with an example embodiment. This embodiment includes a square-shaped housing 74 instead of the rectangular-shaped housing 22 shown in FIG. 2. The square-shaped housing 74 and its exterior components are designed to be waterproofed and to prevent water intrusion to the internal components. The square-shaped housing 74 may comprise silicon rubber or other flexible and durable materials. There is a flexible solar panel 76, mounted to the surface of the square-shaped housing 74. The flexible solar panel 76 may comprise a Power Film Model No. R7 rollable solar panel, which can operate in both dry and wet environments. There is also a light sensor 78 that is mounted beneath a clear plastic area of the square-shaped housing 74. The light sensor 78 may comprise a LilyPad Light Sensor from Sparkfun electronics.

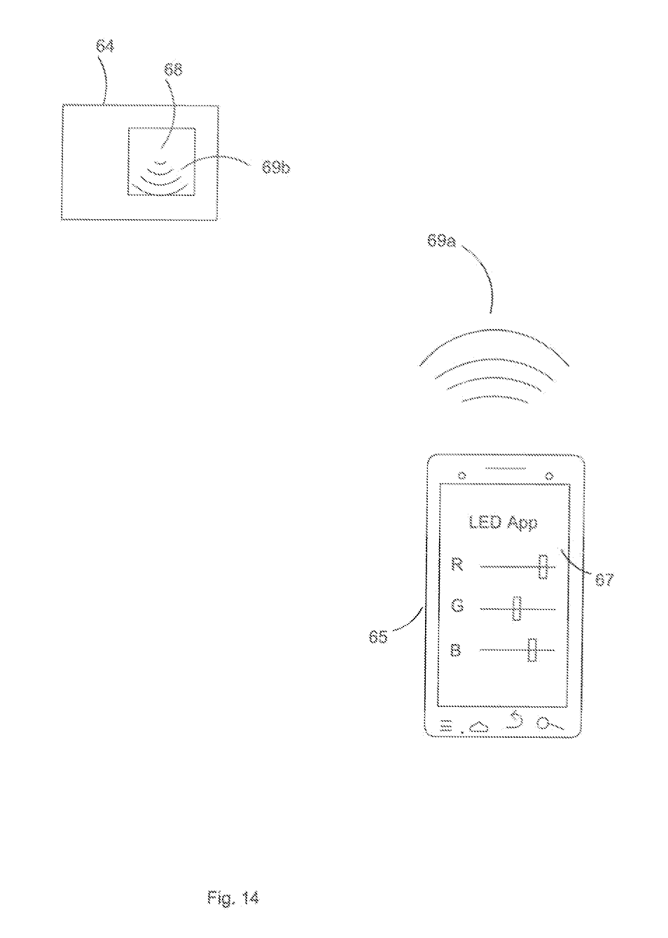

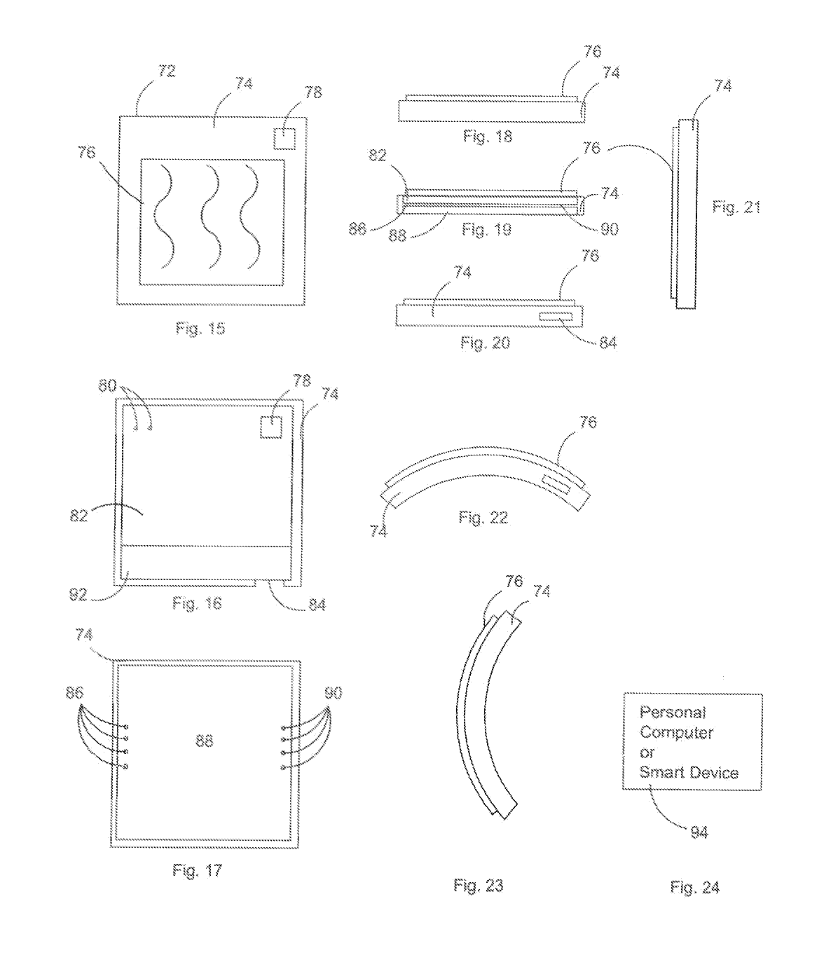

FIG. 16 shows a sectional view of the square LED control assembly 72 in accordance with an example embodiment. The light sensor 78, from FIG. 15, is connected to a circuit board 82. The circuit board 82 may comprise a Paralux TK flexible circuit board substrate. The circuit board 82, transmits power and LED control data to the input/output connector 84, which then transmits power and LED control data to the LED strip 14. The circuit board also receives incoming power from the flexible solar panel 76 in FIG. 15, through the pin connectors 80. The circuit board 82, converts the power from the flexible solar panel 76, to the preferred charging voltage.

FIG. 17 shows a lower sectional view of the square LED control assembly 72 in accordance with an example embodiment. The pin connectors 86, can receive power from the circuit board 82 from FIG. 16 to the internal rechargeable battery 88. The internal rechargeable battery 88 may comprise graphene and carbon nanotubes that are combined to create a flexible supercapacitor. The battery 88 may comprise a Ryden dual carbon battery from Power Japan Plus. The power from the internal rechargeable battery 88, is then transferred back up through the connection pins 90, to the circuit board 82 from FIG. 16 and is converted to the preferred usable voltage of the timer LED controller 92 and LED strip 14 from FIG. 1. The timer LED controller 92, controls the output LED data according to the preprogrammed commands of the user and the commands preprogrammed by the user based on the light sensed by the light sensor 78 of FIG. 15 and FIG. 16. The timer LED controller 92, is programmed by connecting the input/output connector to a personal computer or smart device 94, shown in FIG. 24, and using software to program the desired LED lighting functions.

FIG. 18 shows a side view of the square LED control assembly 72 shown in FIG. 15 in accordance with an example embodiment. FIG. 19 shows a sectional side view of the LED control assembly 72 shown in FIG. 15 in accordance with an example embodiment. FIG. 20 and FIG. 21 show a side view of the LED control assembly 72 shown in FIG. 15 in accordance with an example embodiment. FIGS. 22 and 23 show a flexible side view of the LED control assembly 72 shown in FIG. 15.

FIG. 24 shows a personal computer or smart device 94 that is used to program the timer LED controller 92. The interface between the personal computer or smart device 94 and the LED controller 92 may be implemented using the techniques described in the patent documents previously incorporated by reference.

The flexible functionality of the LED control assembly 72, further enhances the storage versatility of the LED control assembly 72. The flexible LED control assembly 72 could be stored in places such as in the soles of shoes or could conform to a person's wrist or other places that would benefit the use of a flexible LED control assembly 72 over an LED control assembly 72 that is more rigid.

In the embodiment shown in FIGS. 15-24, the LED control assembly 72, includes a flexible solar panel 76 that provides a means for charging the internal rechargeable battery 88. The internal rechargeable battery 88 provides power to the timer LED controller 92. The batteries 44 provide power to the LED strip 14. The timer LED controller 92 controls a connected LED strip 14, based on the preprogrammed commands generated by the personal computer or smart device 94 and what the light sensor 78 senses. In some embodiments, the control of the LED strip 14 may be through light sensors, voice control, music control, motion control, or other types of sensors.

FIG. 25 shows a top view of a rectangular LED control assembly 96 in accordance with an example embodiment. There is a touch screen 100, recessed into the top surface of the rectangular-shaped housing 98. The touch screen 100 may comprise a PiTFT Mini Kit—320×240 2.8″ TFT+Touchscreen for Raspberry Pi.

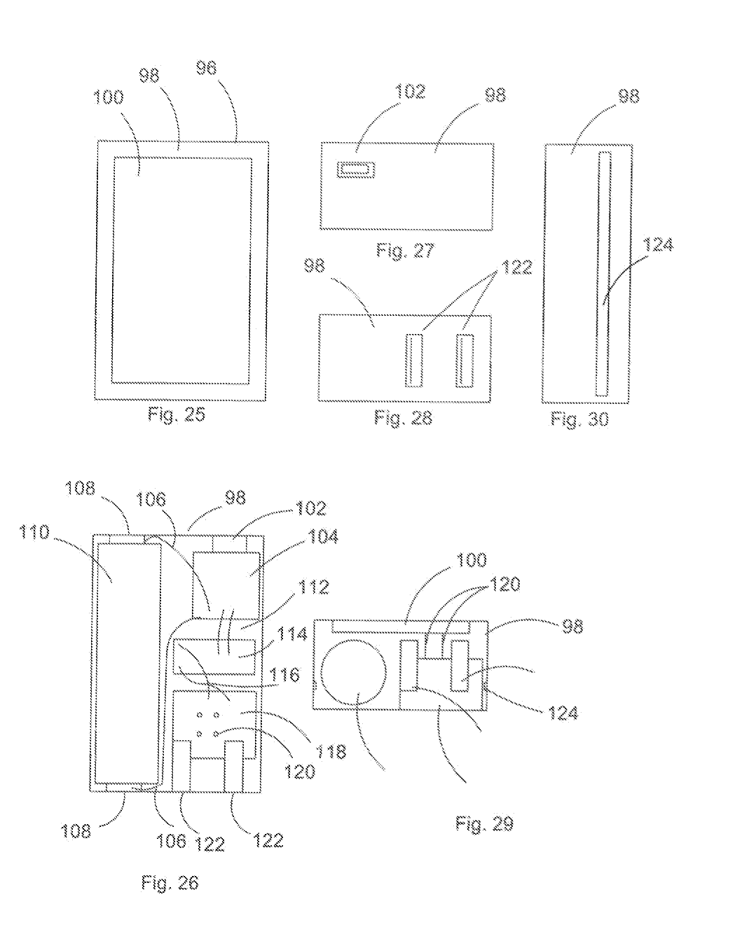

FIG. 26 shows a sectional view of the rectangular LED control assembly 96 in accordance with an example embodiment. The touch screen 100, from FIG. 25, is connected to a touch screen controlled LED controller 118 through data pins 120. The touch screen controlled LED controller 118 may comprise a Raspberry Pi. The circuit board 118, transmits power and LED control data to the output connector 122, which then transmits power and LED control data to multiple LED strips 14, or to multiple portable electronic devices, or a combination of LED strips or portable electronic devices. The charging circuit board 104, is connected to an input charging port 102. The charging circuit board 104 is connected to an internal rechargeable battery 110. The internal rechargeable battery may comprise a Panasonic NCR18650B 3.7 volt lithium ion battery. The charging circuit board 104 is additionally connected to a voltage step up circuit board 114, through power wiring 112. The step up voltage circuit board 114, is connected to a touch screen controlled LED controller 118, through power wiring 116. The touch screen controlled LED controller 118, is connected to a power and data output connector 122, which can be connected to an LED array. The LED array may comprise an individually addressable LED 16×8 pixel WS2812B LED display panel.

The charging circuit board 104, accepts power from an external power source 18, shown in FIG. 1, through the input charging port 102 and converts it to the appropriate voltage to charge the internal rechargeable battery 110. The charging circuit board 104, protects the internal rechargeable battery 110 from harmful voltage ranges and currents while charging the internal rechargeable battery 110. The charging circuit board 104 also protects the internal rechargeable battery 110 from over discharging to dangerously low voltage and low current levels. The charging circuit board 104, also transmits battery power through the power wires 112, to the voltage step up circuit board 114. The voltage step up circuit board takes in the incoming battery power from the internal rechargeable battery 110, and converts it up to the preferred operating voltage of the touch screen controlled LED controller 118 and LED array.

FIG. 27 shows an end view of the rectangular LED control assembly 96 shown in FIG. 25 in accordance with an example embodiment. FIG. 28 shows an opposite end view of the LED control assembly 96 shown in FIG. 25 in accordance with an example embodiment. FIG. 29 shows a sectional end view of the LED control assembly 96 shown in FIG. 25 in accordance with an example embodiment. FIG. 30 shows a side view of the LED control assembly 96 shown in FIG. 25 in accordance with an example embodiment. A grove or notch 124 is recessed into the rectangular housing 98, to provide a means to attach a clip to the LED control assembly 96.

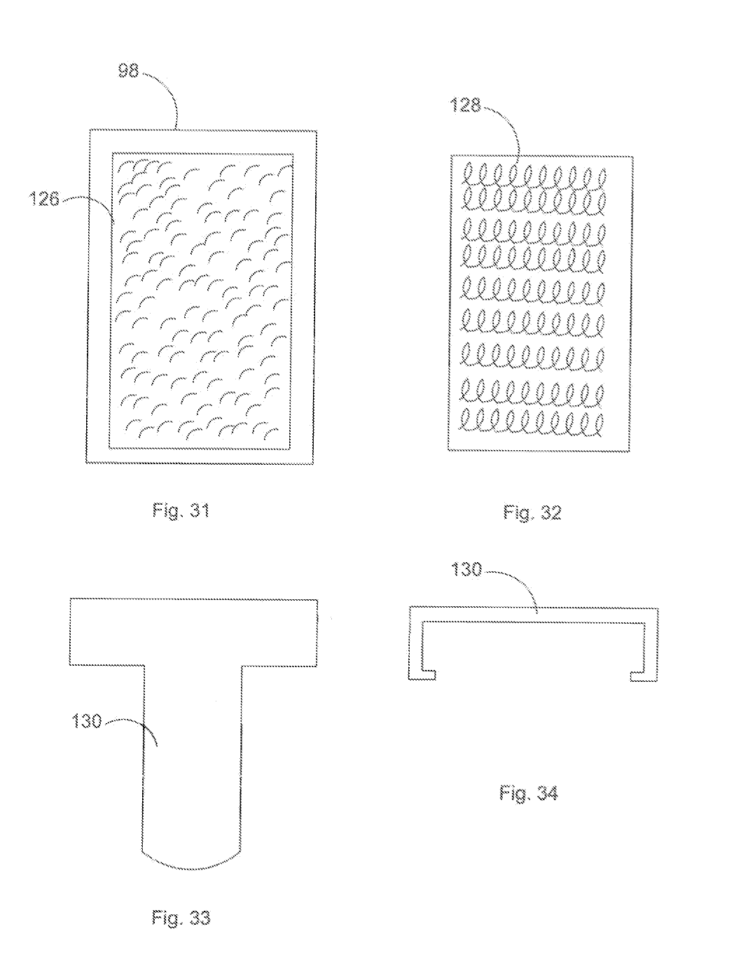

FIG. 31 shows a bottom view of the LED control assembly 96 shown in FIG. 25 in accordance with an example embodiment. Male Velcro 126 is attached to the rectangular housing 98, to provide a means of attachment of the LD control assembly 96 to a separate surface. FIG. 32 shows a piece of female Velcro 128, which can be adhered to any surface and allow the LED control assembly 96 to be attached via the male Velcro 126. FIG. 33 shows a top view of a clip 130 that can provide an alternative means of attachment of the LED control assembly 96 to an object. FIG. 34 shows an end view of clip 130 from FIG. 33.

FIG. 35 shows an example usage of the LED control assembly 96 shown in FIG. 25 in accordance with an example embodiment. The LED control assembly is connected to a portable electronic device 134 through a USB cable 132. The LED control assembly is also connected to an LED array 136. The LED array may comprise an individually addressable 16×8 pixel WS2812B LED display panel.

The LED control assembly 96 shown provides the ability to power and control the attached LED array 126 of by connecting a USB cable 132 from the attached LED array 126 to the output terminals 122. The LED control assembly 96 shown additionally provides the ability of charging a portable electronic device 134 by connecting a USB cable 132 from the attached LED array 126 to the output terminals 122.

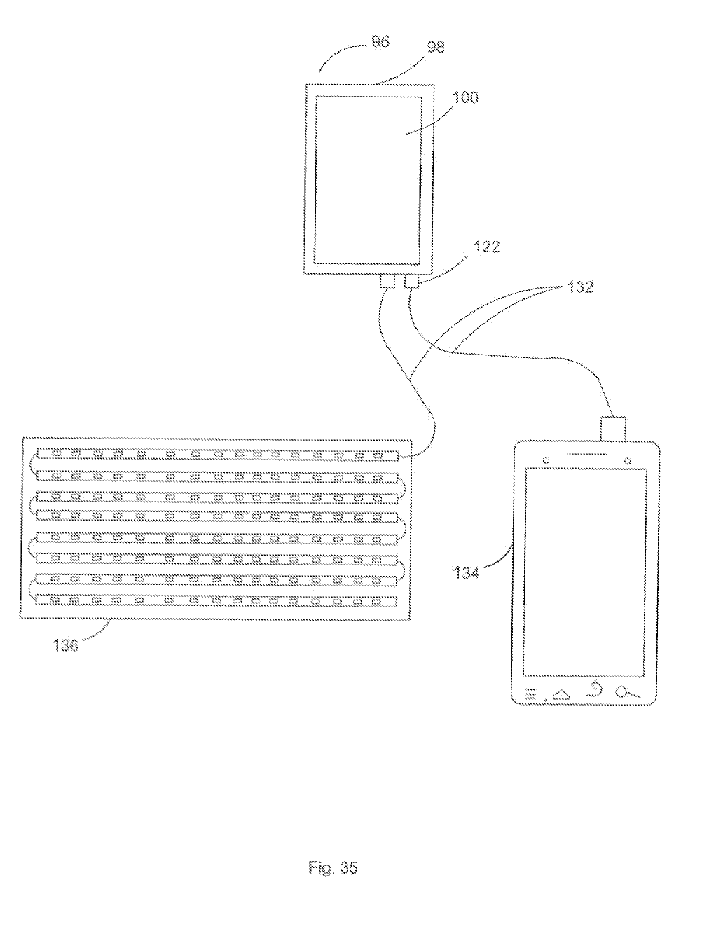

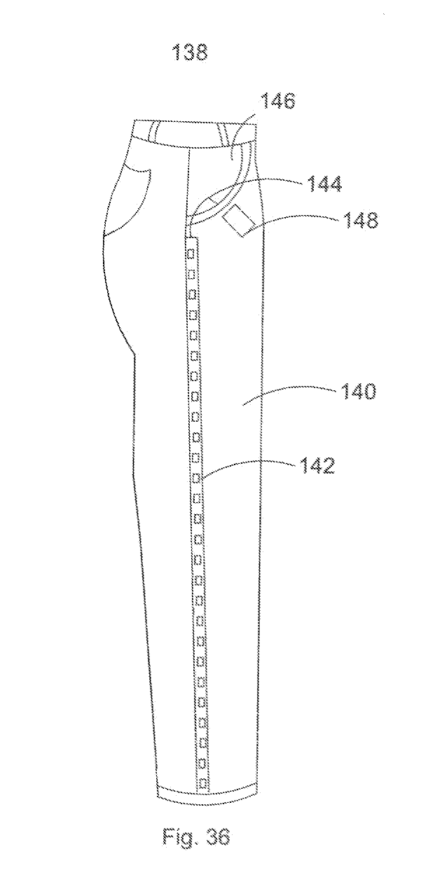

FIG. 36 shows an example usage of the LED control assembly 148 used with LED pants assembly 138 in accordance with an example embodiment. A pair of pants 140, with a strip of LEDs 142 attached to them, connected to an LED control assembly 148, by a connection cable 144. The LED control assembly 148, is easily concealed in the pants pocket 146.

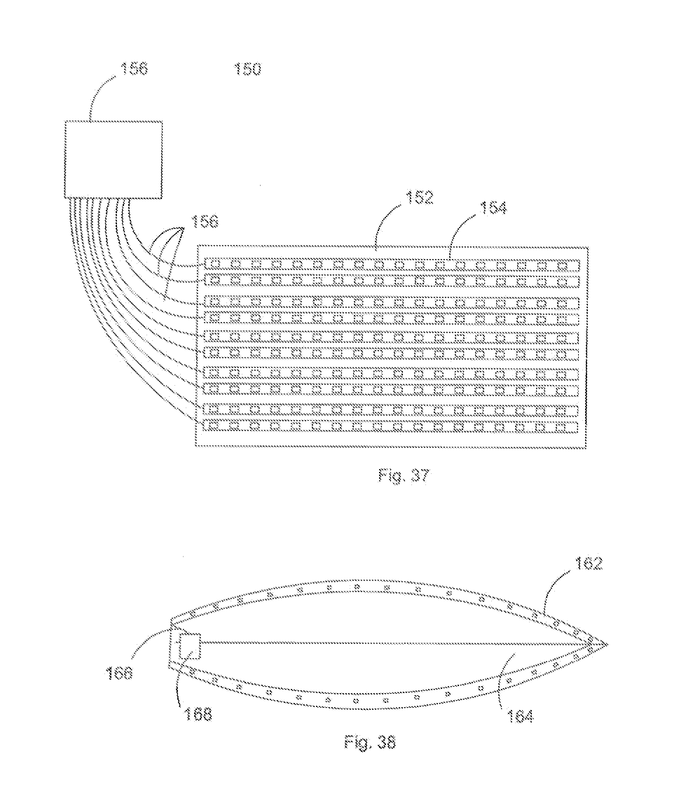

FIG. 37 shows an LED screen assembly 150 using the LED control assembly 158 and an LED screen 152 in accordance with an example embodiment. An LED screen 152 with an array of LEDs 154, is connected to an LED control assembly 158, by connection cables 156. The LED control assembly 158 allows for portable usage of the LED screen 152. The LED screen 152 may comprise an individually addressable LED 16×16 pixel WS2812B LED flexible screen display panel. This LED screen 152 may be used to show text or complex patterns including video feed. The now portable LED screen 152 could be used at sporting events or worn on clothing of entertainers who want to portably display elaborate LED patterns.

FIG. 38 shows an example usage of the LED control assembly 168 used with a surfboard/paddle board 164 with a strip of LEDs 162 in accordance with an example embodiment. A surfboard/paddle board 164, with mounted LEDs 162, is connected to a waterproofed LED control assembly 168, by a connection cable 166. The LED control assembly 168 allows for the user to use LEDs portably in aquatic or high moisture environments. The LED control assembly 168 may be made waterproof by conventional techniques such as by enclosing it in a waterproof enclosure such as those used to waterproof cameras and cell phones.

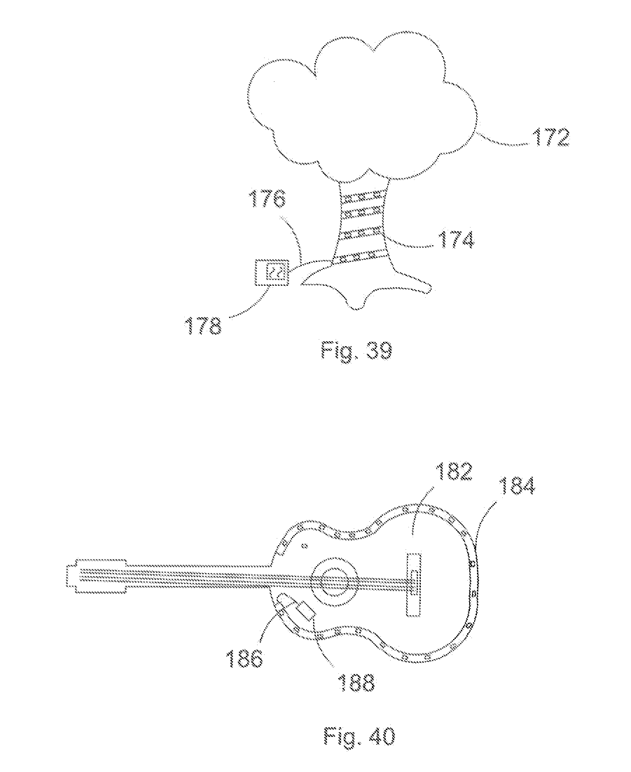

FIG. 39 shows an example usage of the LED control assembly 178 used with LEDs wrapped around a tree 172 in accordance with an example embodiment. A tree 172, wrapped with a strip of LEDs 174, is connected to a waterproofed LED control assembly with solar panels 178, by a connection cable 176. The waterproofed LED control assembly 178 allows for the user to use LEDs outdoors without extension cables.

FIG. 40 shows an example usage of the LED control assembly 188 used with LEDs 184 mounted on a guitar 182 in accordance with an example embodiment. A guitar 182, covered with LEDs 184, is connected to a sound activated LED control assembly 188, by a connection cable 186. The LED control assembly 188 allows for the user to activate the LEDs 184 by playing music. In particular, to enable sound activation, the LED control assembly 188 may include a microphone coupled to the LED controller such that the operation of the LED controller is triggered and/or controlled by an electrical signal received from the microphone.

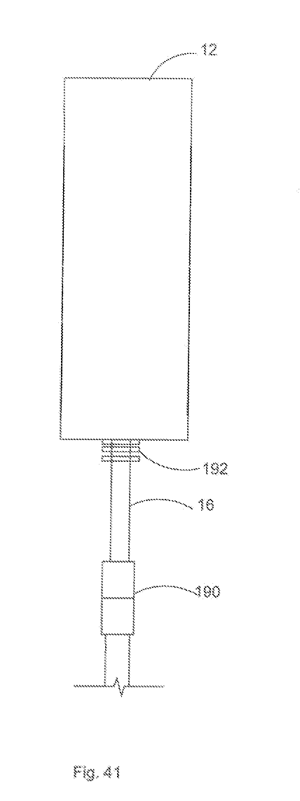

FIG. 41 shows a top view of the LED control assembly 12 with a cable 16 including a cable connector 190 in accordance with an example embodiment. Reinforcing ribs 192 are provided on the cable 16 to increase the strength of the cable 16.

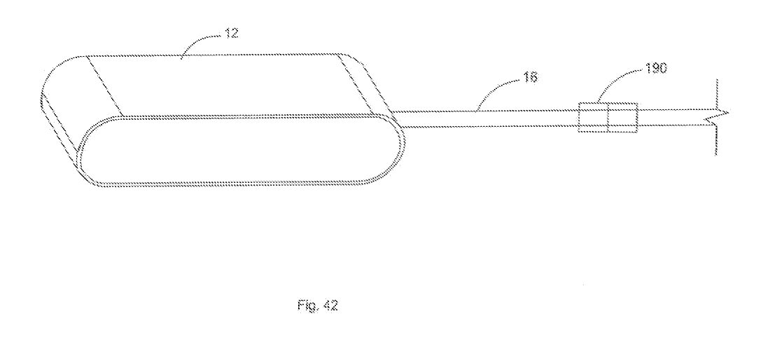

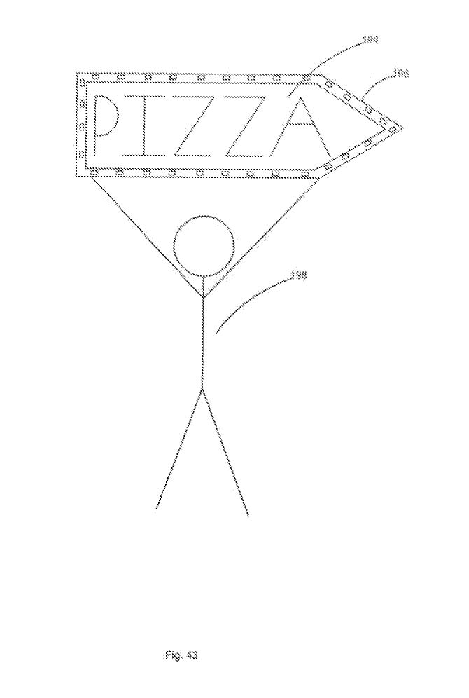

FIG. 42 shows a perspective view of the LED control assembly 12 with a cable 16 including a cable connector 190 in accordance with an example embodiment. The cable connector 190 allows the cable 16 to be disconnected from the LED control assembly 12 without the need for the LED control connector 30 shown in FIG. 2. This saves space inside the LED control assembly 12 because the LED control connector 30 is no longer inside the LED controller 12. This embodiment also provides a stronger connection because the connector 30 may be subject to stress when cable 16 is bent at the point of connection repeatedly moved during use. In contrast, connector 190 is likely to be bent at the point of connection, which results in a stronger, more reliable connection. Additional strength is provided at the point where the cable 16 meets the LED control assembly 12 by the reinforcing ribs 192. The cable 16 and cable connector may comprise a 4 pin IP68 waterproof cable connector.

FIG. 43 shows an example of the LED control assembly 12 used with LEDs 196 mounted on a hand held advertisement sign 194 in accordance with an example embodiment. This allows a person 198, to hold the hand held advertisement sign 194 and attract additional attention with the utilization of the LEDs 196.

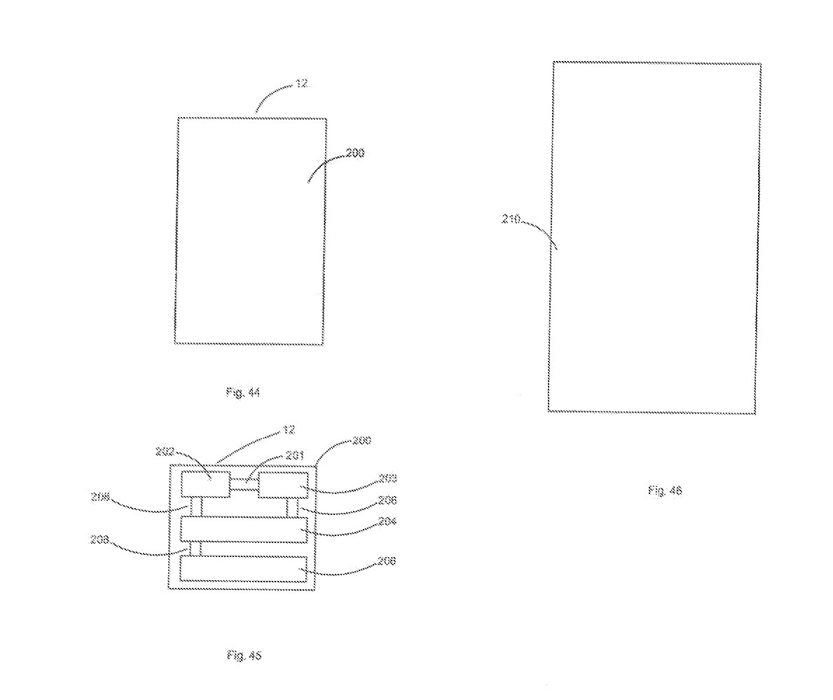

FIG. 44 shows a top view of the LED control assembly 200 in accordance with an example embodiment. A rectangular housing unit 201 encloses the contents of the LED control assembly 200.

FIG. 45 shows a sectional view of the LED control assembly 200 shown in FIG. 44. Rectangular housing unit 12 encloses a battery 204, an LED controller 202, data wiring 201, global positioning system (GPS) unit 203, power wiring 208, and a wireless charging circuit 206. The LED controller 202 may comprise a microcontroller consisting of an Atmega 32u4 Break out Board. The battery 204 may comprise lithium ion battery which may comprise such batteries used in cellular phones such as the Samsung S4. The wireless charging circuit 206 may comprise a Samsung S4 qi wireless charging circuit patch. The GPS unit 203 may comprise an Adafruit Ultimate GPS Breakout Board. The GPS unit 203 can relay positioning information to the LED controller 202, which can be then interpreted to control LED functions of on/off, color control, brightness, and light color pattern. In one embodiment, the GPS unit 203 may be used to notify a user of their progress while running or biking. For example, the LEDs may change color for every mile traveled or for every 100 feet of elevation gained or lost. In another embodiment, the GPS unit 203 may be used for course planning. For example, if a runner wants to go for a six mile run, but doesn't want to plan a course, the runner may set the LED control assembly 200 to start flashing a particular color after three miles have been traveled (as determined by the GPS unit 203) so the runner knows when to turn back.

Additionally the GPS unit 203 can be used to relay positioning information to a smart device such a cell phone or personal computer to provide a tracking log for the user. For example, a GPS tracking log may be used to enable the user to be able to review their miles ran or biked and/or the amount of elevation gained or lost during a trip. Thus, the LED control assembly 200 can replace some of the functionality currently found in conventional GPS enabled watches and other wearables. This allows the user to not have to carry a second device.

FIG. 46 shows an example of a wireless charging pad 210 used to provide wireless charging of the LED control assembly 200 shown in FIG. 44 and FIG. 45. The wireless charging pad 210 may comprise a PowerBot® PB1020 Qi enabled wireless charger inductive charging pad station.

The foregoing description of embodiments has been presented for purposes of illustration and description. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. An LED control assembly comprising:
an LED controller circuit for controlling the operation of external LEDs;
a power supply unit for providing electrical power to the external LEDs, wherein the power supply unit includes a battery;
one or more control devices for providing user control of the LED controller circuit;
electrical connector for providing electrical connections to the external LEDs; and
an enclosure for housing the LED controller circuit, the power supply unit, the one or more control devices, and the electrical connector, wherein the enclosure protects components inside from external elements.

2. The LED control assembly of claim 1 wherein the one or more control devices comprise at least one of: a switch, a receiver, and a sensor.

3. The LED control assembly of claim 1 further comprising an electrical cable having a first terminal at a first end adapted to plug into the electrical connection and a second terminal at a second end adapted to connect into the LED strip.

4. The LED control assembly of claim 3 wherein the electrical cable includes at least 2 to 8 wires.

5. The LED control assembly of claim 1 further comprising a fastening means for attaching the enclosure to an object.

6. The LED control assembly of claim 1 wherein the one or more control devices includes command capabilities comprising at least one of: on/off, color control, brightness, and light color pattern.

7. The LED control assembly of claim 1 further comprising a wireless receiver within the enclosure for receiving wireless signals from outside the enclosure that control the operation of the LED controller circuit.

8. The LED control assembly of claim 7 wherein the wireless receiver receives Bluetooth signals.

9. The LED control assembly of claim 7 wherein the wireless receiver receives signals from a cell phone to control the operation of the LED controller circuit.

10. The LED control assembly of claim 1 wherein the battery is a rechargeable battery and further comprising a second electrical connector for connecting the rechargeable battery to an external charging source.

11. The LED control assembly of claim 1 further comprising a motion sensor within the enclosure and connected to the LED controller to control the operation of the external LEDs in response to movement of the LED control assembly.

12. The LED control assembly of claim 1, wherein the enclosure includes a power indicator, displaying the remaining battery power left.

13. The LED control assembly of claim 1, wherein the enclosure includes a charging indicator, displaying the charging status of the power source.

14. The LED control assembly of claim 1, wherein the LED control circuit is controlled through surface mounted button switch controls.

15. The LED control assembly of claim 1 wherein the LED control circuit is controlled through surface mounted dial switches.

16. The LED control assembly of claim 1 wherein the LED control circuit is controlled through surface mounted slide switches.

17. The LED control assembly of claim 1, wherein the LED control circuit is controlled through an infrared (IR) receiver and emitting remote.

18. The LED control assembly of claim 1, wherein the LED control circuit is controlled through a touch screen mounted to the housing.

19. The LED control assembly of claim 1, wherein the LED control circuit is controlled through a sound activation sensor.

20. The LED control assembly of claim 1, wherein the LED control circuit is controlled through by sensing voice activation commands.

21. The LED control assembly of claim 1, wherein the LED controller control circuit is controlled through a radio frequency (RF) receiver and emitting remote.

22. The LED control assembly of claim 1, wherein the LED control circuit has a timer function and circuit that allows the user to set a specific time and time interval for which the attached arrays or strips of LEDs operates.

23. The LED control assembly of claim 1, wherein the LED control circuit has a light sensor that detects day time and night time and allows the user to choose how this information controls the attached arrays or strips of LEDs.

24. The LED control assembly of claim 1, wherein the enclosure includes a solar panel or solar panels to charge the battery power supply.

25. The LED control assembly of claim 1, wherein the enclosure is designed to resist aquatic or high moisture conditions.

26. The LED control assembly of claim 1, wherein the enclosure includes an adjustable power usage controls to reduce or increase the amount of power used by the LED array or strips.

27. The LED control assembly of claim 1, wherein the LED control circuit can be reprogrammed via computer, cell phone, or smart device.

28. The LED control assembly of claim 1, wherein the LED control assembly is made out of flexible components, which allow for the LED control assembly to be flexible in nature.

29. The LED control assembly of claim 1, wherein the LED control assembly has the ability to charge portable electronics such as cell phones, laptops, and other electronic devices.

30. An LED control assembly comprising:
an LED controller circuit for controlling the operation of external LEDs;
a power supply unit for providing electrical power to the external LEDs, wherein the power supply unit includes a battery;
one or more control devices for providing user control of the LED controller circuit;
electrical connector for providing electrical connections to the external LEDs;
an enclosure for housing the LED controller circuit, the power supply unit, the one or more control devices, and the electrical connector, wherein the enclosure protects components inside from external elements; and
a wireless receiver within the enclosure for receiving wireless signals from outside the enclosure that control the operation of the LED controller circuit, wherein the wireless receiver receives signals from a portable electronic device to control the operation of the LED controller circuit.

31. The LED control assembly of claim 30 further comprising a portable electronic device having application software installed therein for facilitating user control of the operation of the external LEDs by controlling the wireless signals transmitted to the wireless receiver.

32. An LED control assembly comprising:
an LED controller circuit for controlling the operation of external LEDs;
a power supply unit for providing electrical power to the external LEDs, wherein the power supply unit includes a battery;
one or more control devices for providing user control of the LED controller circuit; and
an enclosure for housing the LED controller circuit, the power supply unit, the one or more control devices, and the electrical connector, wherein the enclosure protects components inside from external elements.

33. The LED control assembly of claim 32 further comprising:
electrical connector for providing electrical connections to the external LEDs; and
an electrical cable extending from inside the enclosure to outside the enclosure connecting the LED control assembly to the external LEDs.

34. The LED control assembly of claim 33 wherein the electrical cable further comprises a connector assembly in close proximity to the enclosure enabling the enclosure to be disconnected from the external LEDs.

35. The LED control assembly of claim 32 further comprising a wireless charging circuit within the enclosure and an external wireless charging pad, wherein the battery may be charged wirelessly.

36. The LED control assembly of claim 32 further comprising a GPS unit coupled to the LED controller circuit for providing positioning information wherein the LED controller circuit changes the display of the external LEDs based on the GPS location.

37. The LED control assembly of claim 32 further comprising a GPS unit coupled to the LED controller circuit for providing positioning information wherein the GPS unit sends location information to an external device to provide a tracking log of locations during a trip of the user.
